(19) United States
(12) Patent Application Publication
(10) Pub. No.: US 2026/0302238 A1
(43) Pub. Date: Oct. 1, 2026

(54) NEGATIVE ELECTRODE, SOLID LITHIUM ION BATTERY, AND NEGATIVE ELECTRODE MANUFACTURING METHOD

(71) Applicant: HONDA MOTOR CO., LTD., Tokyo (JP)

(72) Inventors: Masataka FURUYAMA, Saitama (JP); Narumi OHTA, Saitama (JP); Wataru SHIMIZU, Saitama (JP); Hiroshi SAKAI, Saitama (JP); Takamitsu ONUMA, Saitama (JP); Takafumi NAGAI, Saitama (JP); Shodai KATO, Saitama (JP); Makoto IDEMOTO, Saitama (JP)

(21) Appl. No.: 19/632,440

(22) Filed: Mar. 30, 2026

(30) Foreign Application Priority Data
Mar. 31, 2025 (JP) 2025-059480

(51) Int. Cl. H01M 4/62; H01M 4/02; H01M 4/133; H01M 4/134; H01M 4/38; H01M 4/587; H01M 10/0525

(52) U.S. Cl. CPC H01M 4/62; H01M 4/133; H01M 4/134; H01M 4/386; H01M 4/587; H01M 10/0525; H01M 2004/027

(57) ABSTRACT

Provided is a negative electrode including a negative electrode composite material layer containing a silicon-based active material and a solid electrolyte. A 25 μm-square region in a 5000× backscattered electron image of a section of the negative electrode composite material layer is divided into X₁ segments, . . . , and into Xₙ segments (X₁, . . . , and Xₙ are each different integers of 2 or larger) such that the segments have uniform areas, then average values SX_{1,ave} [%], . . . , and SX_{n,ave} [%] of area proportions [%] occupied by regions attributed to the silicon-based active material as well as average values SX_{1,ave}′ [%], . . . , and SX_{n,ave}′ [%] of area proportions [%] occupied by regions attributed to the solid electrolyte in ternarized regions are determined, and then average values S [%] of SX_{1,ave}, . . . , and SX_{n,ave}, as well as average values S′ [%] of SX_{1,ave}′, . . . , and SX_{n,ave}′ are, determined. At this time, the following equation is satisfied:

$$90 \leq S + {S}^{′} .$$

This application is based on and claims the benefit of priority from Japanese Patent Application No. 2025-059480, filed on 31 Mar. 2025, the content of which is incorporated herein by reference.

### BACKGROUND OF THE INVENTION

### Field of the Invention

The present invention relates to a negative electrode, a solid lithium ion battery, and a negative electrode manufacturing method.

### Related Art

In recent years, lithium ion secondary batteries that contribute to energy efficiency have been researched and developed for more people to securely access an affordable, reliable, sustainable, and advanced energy.

Japanese Unexamined Patent Application, Publication No. 2024-148560 describes a negative electrode active material layer containing silicon active material particles and solid electrolyte particles. In this case, the silicon active material particles have an oxygen atomic weight of less than 5.0 mass %, and the solid electrolyte particles have an average particle diameter of 1.0 μm or smaller. Also, Japanese Unexamined Patent Application, Publication No. 2024-148560 describes a solid secondary battery having a negative electrode active material layer.
Patent Document 1: Japanese Unexamined Patent Application, Publication No. 2024-148560

### SUMMARY OF THE INVENTION

However, it is likely that fillability of the silicon active material particles and solid electrolyte particles is low in the negative electrode active material layer described in Japanese Unexamined Patent Application, Publication No. 2024-148560, and consequently, the solid secondary battery has a low initial discharge capacity and a large unevenness in the initial discharge capacity. Herein, if the solid secondary battery has a large unevenness in the initial discharge capacity, the solid secondary battery cannot be stably used.

An object of the present invention is to provide a negative electrode capable of increasing an initial discharge capacity of a solid lithium ion battery and decreasing an unevenness in an initial discharge capacity of the solid lithium ion battery.

(1) A negative electrode including a negative electrode composite material layer containing a silicon-based active material and a solid electrolyte, in which the following equation is satisfied:

90≤S+S′, and
the average values S and the average values S′ are determined through a process that a 25 μm-square region in a 5000× backscattered electron image of a section of the negative electrode composite material layer is divided into X₁ segments, into X₂ segments, . . . , into Xₙ₋₁ segments, and into Xₙ segments (X₁, X₂, . . . , Xₙ₋₁, and Xₙ are each different integers of 2 or larger) such that the segments have uniform areas, then average values SX_{1,ave} [%], SX_{2,ave} [%], . . . , SX_{n-1,ave} [%], and SX_{n,ave} [%] of area proportions [%] occupied by regions attributed to the silicon-based active material as well as average values SX_{1,ave}′ [%], SX_{2,ave}′ [%], . . . , SX_{n-1,ave}′ [%], and SX_{n,ave}′ [%] of area proportions [%] occupied by regions attributed to the solid electrolyte in ternarized regions are determined, and then average values S [%] of SX_{1,ave}, SX_{2,ave}, . . . , SX_{n-1,ave}, and SX_{n,ave}, as well as average values S′ [%] of SX_{1,ave}′, SX_{2,ave}′, . . . , SX_{n-1,ave}′, and SX_{n,ave}′ are determined.

(2) The negative electrode according to (1), in which an average value Sₐᵥₑ′ [%] of the average values S′ satisfies the following equation:

$$10 \leq {S}_{ave}^{′} \leq 50.$$

(3) The negative electrode according to (1) or (2), in which an average value Sₐᵥₑ [%] of the average values S satisfies the following equation:

$$50 \leq {S}_{a v e} \leq 80 .$$

(4) The negative electrode according to any one of (1) to (3), in which the solid electrolyte has a median diameter of 100 nm or larger and 1000 nm or smaller.

(5) The negative electrode according to any one of (1) to (4), in which the negative electrode composite material layer has a solid electrolyte content of 10 mass % or more and 50 mass % or less.

(6) The negative electrode according to any one of (1) to (5), in which the negative electrode composite material layer has a silicon-based active material content of 50 mass % or more and 80 mass % or less.

(7) The negative electrode according to any one of (1) to (6), in which the negative electrode composite material layer additionally contains a conductive assistant.

(8) The negative electrode according to (7), in which the negative electrode composite material layer has a conductive assistant content of 0.1 mass % or more and 5 mass % or less.

(9) The negative electrode according to (7) or (8), in which the conductive assistant is carbon.

(10) The negative electrode according to any one of (7) to (9), in which the conductive assistant is a particle having a median diameter of 10 nm or larger and 100 nm or smaller, or a fiber having a diameter of 1 nm or larger and 10 nm or smaller.

(11) The negative electrode according to any one of (1) to (10), in which the solid electrolyte is a solid sulfide electrolyte.

(12) The negative electrode according to (11), in which the solid sulfide electrolyte is an argyrodite type solid sulfide electrolyte.

(13) A negative electrode including a negative electrode composite material layer containing a silicon-based active material and a solid electrolyte, in which an average value Sₐᵥₑ [%] of average values S, an average value Sₐᵥₑ′ [%] of average values S′, the maximum value (S+S′)ₘₐₓ of (S+S′), and the minimum value (S+S′)ₘᵢₙ of (S+S′) satisfy the following equation:

$$[ {( S + {S}^{′} )}_{max} - {( S + {S}^{″} )}_{min} ] / ( {S}_{a v e} + {S}_{a v e} ) \leq 0.1 ,$$

and
the average value Sₐᵥₑ of the average values S and the average value Sₐᵥₑ′ of the average values S′ are determined through a process that a 25 μm-square region in a 5000× backscattered electron image of a section of the negative electrode composite material layer is divided into X₁ segments, into X₂ segments, . . . , into Xₙ₋₁ segments, and into Xₙ segments (X₁, X₂, . . . , Xₙ₋₁, and Xₙ are each different integers of 2 or larger) such that the segments have uniform areas, then average values SX_{1,ave} [%], SX_{2,ave} [%], . . . , SX_{n-1,ave} [%], and SX_{n,ave} [%] of area proportions [%] occupied by regions attributed to the silicon-based active material as well as average values SX_{1,ave}′ [%], SX_{2,ave}′ [%], SX_{n-1,ave}′ [%], and SX_{n,ave}′ [%] of area proportions [%] occupied by regions attributed to the solid electrolyte in ternarized regions are determined, and then average values S [%] of SX_{1,ave}, SX_{2,ave}, . . . , SX_{n-1,ave}, and SX_{n,ave}, as well as average values S′ [%] of SX_{1,ave}′, SX_{2,ave}′, . . . , SX_{n-1,ave}′, and SX_{n,ave}′ are determined.

(14) A solid lithium ion battery including the negative electrode according to any one of (1) to (13).

(15) A negative electrode manufacturing method according to any one of (1) to (13), including applying a slurry containing the silicon-based active material, the solid electrolyte, and a solvent onto a negative electrode current collector to form the negative electrode composite material layer, in which the solvent has a boiling point of 120° C. or higher.

(16) The negative electrode manufacturing method according to (15), in which the applied slurry is heat-dried under normal pressure, then heat-dried under reduced pressure to form the negative electrode composite material layer.

(17) The negative electrode manufacturing method according to (15) or (16), additionally including: mixing a conductive assistant and the solvent to obtain a first mixture, mixing the first mixture, the solid electrolyte, and the solvent to obtain a second mixture; and mixing the second mixture, the silicon-based active material, and the solvent to obtain the slurry.

According to the present invention, it is possible to provide a negative electrode capable of increasing an initial discharge capacity of a solid lithium ion battery and decreasing unevenness in the initial discharge capacity of the solid lithium ion battery.

### DETAILED DESCRIPTION OF THE INVENTION

The embodiment of the present invention will be explained below.

### [Negative Electrode]

A negative electrode according to this embodiment includes a negative electrode composite material layer containing a silicon-based active material and a solid electrolyte.

In the first aspect of the negative electrode according to this embodiment, a 25 μm-square region in a 5000× backscattered electron image of a section of the negative electrode composite material layer is divided into X₁ segments, into X₂ segments, . . . , into Xₙ₋₁ segments, and into Xₙ segments (X₁, X₂, . . . , Xₙ₋₁, and Xₙ are each different integers of 2 or larger) such that the segments have uniform areas, then average values SX_{1,ave} [%], SX_{2,ave} [%], . . . , SX_{n-1,ave} [%], and SX_{n,ave} [%] of area proportions [%] occupied by regions attributed to the silicon-based active material as well as average values SX_{1,ave}′ [%], SX_{2,ave}′ [%], . . . , SX_{n-1,ave}′ [%], and SX_{n,ave}′ [%] of area proportions [%] occupied by regions attributed to the solid electrolyte in ternarized regions are determined, and then average values S [%] of SX₁, ave, SX_{2,ave}, . . . , SX_{n-1,ave}, and SX_{n,ave}, as well as average values S′ [%] of SX_{1,ave}′, SX_{2,ave}′, . . . , SX_{n-1,ave}′, and SX_{n,ave}′ are determined. At this time, it is preferable that the following equations are satisfied:

$$90 \leq S + {S}^{′}$$

$$and$$

$$94 \leq S + {S}^{′} .$$

Since a solution of equation S+S′ is 90% or higher, the fillability of the silicon-based active material and solid electrolyte is improved, and consequently, the solid lithium ion battery has a high initial discharge capacity and a small unevenness in the initial discharge capacity. For example, the solution of equation S+S′ is 99.9% or lower. In this process, based on analysis results from an energy dispersive x-ray fluorescence spectroscopic analyzer (EDX), the ternarized regions can be assigned to regions containing no active material or solid electrolyte, regions attributed to the active material, and regions attributed to the solid electrolyte. Herein, the combination of X₁, X₂, . . . , Xₙ₋₁, and Xₙ may be e.g. a combination of 4, 9, 16, and 25 without particular limitation.

In the second aspect of the negative electrode according to this embodiment, it is preferable that the average value Sₐᵥₑ [%] of the average values S, the average value Sₐᵥₑ′ of the average values S′, the maximum value (S+S′)ₘₐₓ of (S+S′), and the minimum value (S+S′)ₘᵢₙ of (S+S′) satisfy the following equations:

$$[ {( S + {S}^{′} )}_{max} - {( S + {S}^{′} )}_{min} ] / ( {S}_{ave} + {S}_{ave}^{′} ) \leq 0 \text{.100}$$

$$and$$

$$[ {( S + {S}^{′} )}_{max} - {( S + {S}^{′} )}_{min} ] / ( {S}_{ave} + {S}_{ave}^{′} ) \leq 0.060 .$$

Since the solution of equation [(S+S′)ₘₐₓ−(S+S′)ₘᵢₙ]/(Sₐᵥₑ+Sₐᵥₑ′) is 0.100 or smaller, the unevenness in the fillability of the silicon-based active material and the solid electrolyte is small, and consequently the solid lithium ion battery has a high initial discharge capacity and a small unevenness in the initial discharge capacity. For example, the solution of equation [(S+S′)ₘₐₓ−(S+S′)ₘᵢₙ]/(Sₐᵥₑ+Sₐᵥₑ′) is 0.001 or larger.

The second aspect of the negative electrode according to this embodiment may double as the first aspect of the negative electrode according to this embodiment.

In this condition, the average value Sₐᵥₑ′ [%] of the average values S′ preferably satisfies the following equation:

$$10 \leq {S}_{ave}^{′} \leq 50 ,$$

more preferably

$$15 \leq {S}_{ave}^{′} \leq 45.$$

If the average value Sₐᵥₑ′ satisfies the following equation:

$$10 \leq {S}_{ave}^{′} \leq 50 ,$$

the fillability of the silicon-based active material and the solid electrolyte is improved.

The average value Sₐᵥₑ [%] of the average values S preferably satisfies the following equation:

$$50 \leq {S}_{ave} \leq 80 ,$$

more preferably

$$50 \leq {S}_{a v e} \leq 75 .$$

If the average value Sₐᵥₑ′ satisfies the following equation:

$$50 \leq {S}_{ave} \leq 80 ,$$

the fillability of the silicon-based active material and the solid electrolyte is improved.

The solid electrolyte has a median diameter of preferably 100 nm or larger and 1000 nm or smaller, more preferably 150 nm or larger and 800 nm or smaller, even more preferably 200 nm or larger and 800 nm or smaller. When the solid electrolyte has a median diameter of 100 nm or larger, aggregation of the solid electrolyte is suppressed, and consequently the solid lithium ion battery has a high initial discharge capacity. On the other hand, when the solid electrolyte has a median diameter of 1000 nm or smaller, the fillability of the silicon-based active material and the solid electrolyte is improved, and consequently the solid lithium ion battery has a high initial discharge capacity.

The negative electrode composite material layer has a solid electrolyte content of preferably 10 mass % or more and 50 mass % or less, more preferably 15 mass % or more and 40 mass % or less, even more preferably 20 mass % or more and 40 mass % or less. When the negative electrode composite material layer has a solid electrolyte content of 10 mass % or more and 50 mass % or less, the fillability of the silicon-based active material and the solid electrolyte is improved.

The negative electrode composite material layer has a silicon-based active material content of preferably 50 mass % or more and 80 mass % or less, more preferably 50 mass % or more and 75 mass % or less. When the negative electrode composite material layer has a silicon-based active material content of 50 mass % or more and 80 mass % or less, the fillability of the silicon-based active material and the solid electrolyte is improved.

Examples of the silicon-based active material include, but are not particularly limited to, elemental silicon, a silicon alloy, a silicon oxide, and a composite material containing silicon and a heterogeneous element different from silicon. Examples of the silicon alloy include an SiC alloy, an SiN alloy, an SiTi alloy, an SiAl alloy, an SiLi alloy, and an SiCu alloy. Examples of the silicon oxide include SiO. Examples of the composite material containing silicon and a heterogeneous element different from silicon include a silicon-lithium composite material, a silicon-carbon composite material, and a silicon-aluminum composite material. The composite material containing silicon and a heterogeneous element different from silicon may be or may not be any silicon alloy.

A silicon-based active material 1 is preferably a composite material containing silicon and a heterogeneous element different from silicon, from the viewpoints of the dispersibility and fillability of the silicon-based active material and solid electrolyte.

The solid electrolyte is not particularly limited as long as it can conduct lithium ions, and examples of the solid electrolyte include a solid oxide electrolyte and a solid sulfide electrolyte. Above all, a solid sulfide electrolyte is preferable, and an argyrodite type solid sulfide electrolyte is particularly preferable from the viewpoint of dispersibility of the silicon-based active material and the solid electrolyte. Also, from the viewpoint of the lithium ion conductivity, a solid sulfide electrolyte is preferable, and an argyrodite type solid sulfide electrolyte is particularly preferable. When the solid electrolyte has a high lithium ion conductivity, the lithium ion conduction resistance inside of the negative electrode is decreased, and therefore the solid lithium ion battery has a higher initial discharge capacity.

The solid sulfide electrolyte contains, for example, a metal element (M) that serves as the ion to be conducted and sulfur(S). Examples of M include Li, Na, K, Mg, and Ca. Above all, Li is preferable.

The solid sulfide electrolyte preferably contains Li, one or more elements A selected from a group consisting of P, Si, Ge, Al, and B, as well as S, more preferably contains Li and P. From the viewpoint of the ionic conductivity, the solid sulfide electrolyte may additionally contain a halogen element (e.g. Cl, Br, I). The solid sulfide electrolyte may additionally contain O.

Examples of the solid sulfide electrolyte include Li₂S—P₂S₅, Li₂S—P₂S₅—LiI, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are positive numbers, and Z is Ge, Zn, or Ga), Li₂S—GeS₂, Li₂S—SiS₂—Li₃PO₄, Li₂S—SiS₂—LiₓMo_{y} (x and y are positive numbers, and M is P, Si, Ge, B, Al, Ga, or In), and LiᵥP_{w}SₓCl_{y}Br_{z} (v, w, x, y, z>0). Above all, LiᵥP_{w}SₓCl_{y}Br_{z} (v, w, x, y, z>0) is preferable because it exhibits a low reaction resistance even after repeated charging/discharging cycles, and from the viewpoint of the ionic conductivity, LiᵥP_{w}SₓCl_{y}Br_{z} (0<v<10, 0<w<5, 0<x<5, 0<y<5, 0<z<5) is more preferable and can be exemplified by Li_{5.4}PS_{4.4}Cl_{0.8}Br_{0.8}.

For example, the description “Li₂S—P₂S₅” refers to a solid sulfide electrolyte formed from a raw material composition containing Li₂S and P₂S₅. The same applies to other descriptions.

The solid sulfide electrolyte may be a sulfide glass or a crystallized sulfide glass, or may be a crystalline material obtained by a solid-phase method. For example, the sulfide glass is obtained by subjecting a raw material composition to a mechanical milling method (e.g. a milling method using a ball mill). The crystallized sulfide glass is obtained, for example, by heat-treating a sulfide glass at its crystallization temperature or higher.

Preferably, the negative electrode composite material layer additionally contains a conductive assistant. Thereby, the fillability of the silicon-based active material and the solid electrolyte is improved, and consequently, the solid lithium ion battery has a higher initial discharge capacity and a smaller unevenness in the initial discharge capacity.

Preferably, the conductive assistant is a particle having a median diameter of 10 nm or larger and 100 nm or smaller, or a fiber having a diameter of 1 nm or larger and 10 nm or smaller. Thereby, the solid lithium ion battery has a higher initial discharge capacity and a smaller unevenness in the initial discharge capacity. At this time, the particle has a median diameter of more preferably 20 nm or larger and 80 nm or smaller, even more preferably 35 nm or larger and 50 nm or slammer. More preferably, the fiber has a diameter of 1 nm or larger and 5 nm or smaller.

Examples of the conductive assistant include, but are not particularly limited to, acetylene black, multi-walled carbon nanotube (MCNT), and single-walled carbon nanotube (SCNT).

The negative electrode composite material layer has a conductive assistant content of preferably 0.1 mass % or more and 5 mass % or less, more preferably 0.1 mass % or more and 3 mass % or less. When the negative electrode composite material layer has a conductive assistant content of 0.1 mass % or more and 5 mass % or less, the fillability of the silicon-based active material and solid electrolyte is further improved.

The negative electrode composite material layer may additionally contain a binder. The negative electrode composite material layer has a binder content of e.g. 0.5 mass % or more and 3 mass % or less without particular limitation. Examples of the binder include, but are not particularly limited to, styrene-butadiene rubber, polyvinylidene fluoride, polytetrafluoroethylene, acrylic resin, and polyimide.

The negative electrode composite material layer has a thickness of preferably 10 μm or larger and 100 μm or smaller, more preferably 15 μm or larger and 50 μm or smaller. When the negative electrode composite material layer has a thickness of 10 μm or larger and 100 μm or smaller, the solid lithium ion battery has a high initial discharge capacity.

Examples of the method for forming the negative electrode composite material layer include, but are not particularly limited to, a method of applying a slurry containing a silicon-based active material, a solid electrolyte, and a solvent onto a negative electrode current collector. The solvent has a boiling point of preferably 120° C. or higher, more preferably 150° C. or higher. When the solvent has a boiling point of 120° C. or higher, rapid evaporation of the solvent during the application of the slurry is suppressed. Thereby, excessive aggregation between components in the slurry can be suppressed, resulting in high fillability of the silicon-based active material and solid electrolyte. For example, the solvent has a boiling point of 180° C. or lower.

Examples of the solvent having a boiling point of 120° C. or higher include, but are not particularly limited to, butyl butyrate (boiling point: 166° C.), o-xylene (boiling point: 144° C.), m-xylene (boiling point: 139° C.), p-xylene (boiling point: 138° C.), and decane (boiling point: 174° C.). Above all, butyl butyrate is preferable from the viewpoint of the fillability of the silicon-based active material and solid electrolyte.

When forming the negative electrode composite material layer, it is preferable that the applied slurry is heat-dried under normal pressure, followed by reduced pressure. Thereby, the fillability of the silicon-based active material and the solid electrolyte is improved.

When preparing the slurry, it is preferable that a conductive assistant dispersion liquid, a solid electrolyte, and a solvent are mixed to obtain a mixture, and then this mixture, a silicon-based active material, and a solvent are mixed. Thereby, the fillability of the silicon-based active material and solid electrolyte is improved.

The negative electrode according to this embodiment has a negative electrode composite material layer formed on a negative electrode current collector, for example, and is applicable to a solid lithium ion battery.

Examples of the material constituting the negative electrode current collector include, but are not particularly limited to, silver, palladium, gold, platinum, aluminum, copper, nickel, stainless steel, and carbon. Above all, copper, stainless steel, and nickel are preferable from the viewpoint of conductivity and cost.

Examples of the shape of the negative electrode current collector include, but are not particularly limited to, a foil shape, a plate shape, a mesh shape, a non-woven fabric shape, and a foam shape.

The negative electrode current collector has a thickness of e.g. 0.1 μm or larger and 1 mm or smaller without particular limitation.

### [Solid Lithium Ion Battery]

The solid lithium ion battery according to this embodiment includes the negative electrode according to this embodiment, and additionally includes, for example, a positive electrode and an electrolyte. Examples of the electrolyte include, but are not particularly limited to, a solid electrolyte or a gel electrolyte. An all-solid-state lithium ion battery including a solid electrolyte layer will be explained below.

### (Solid Electrolyte Layer)

Examples of the solid electrolyte constituting the solid electrolyte layer include, but are not particularly limited to, a solid sulfide electrolyte and a solid oxide electrolyte. Above all, a solid sulfide electrolyte is preferable, and an argyrodite type solid sulfide electrolyte is particularly preferable from the viewpoint of the initial coulombic efficiency of the lithium ion secondary battery according to this embodiment.

The solid sulfide electrolyte contained in the solid electrolyte layer is the same as the solid sulfide electrolyte contained in the negative electrode composite material layer.

The form of the solid electrolyte can be exemplified by a particle form without particular limitation.

The solid electrolyte layer has a solid electrolyte content of e.g. 50 mass % or more and 99 mass % or less without particular limitation.

The solid electrolyte layer may additionally contain a binder and the like.

Examples of the method for forming the solid electrolyte layer include, but are not particularly limited to, a method of applying a slurry containing a solid electrolyte and a solvent onto the negative electrode current collector. The solid electrolyte layer has a thickness of e.g. 0.1 μm or larger and 1000 μm or smaller.

### (Positive Electrode)

For example, the positive electrode includes a positive electrode composite material layer formed on a positive electrode current collector.

The positive electrode composite material layer contains a positive electrode active material. Examples of the positive electrode active material include, but are not particularly limited to, lithium cobaltate (LiCoO₂), lithium nickelate (LiNiO₂), LiNiₚMn_{q}COᵣO₂ (p+q+r=1), LiNiₚAl_{q}CoᵣO₂ (p+q+r=1), lithium manganate (LiMn₂O₄), Li₁₊ₓMn_{2-x-y}M_{y}O₄ (x+y=2) (M is one or more elements selected from a group consisting of Al, Mg, Co, Fe, Ni, and Zn), lithium titanate, and LiMPO₄ (M is one or more elements selected from a group consisting of Fe, Mn, Co, and Ni).

The positive electrode composite material layer has a positive electrode active material content of e.g. 50 mass or more and 99 mass % or less without particular limitation.

The positive electrode composite material layer may additionally contain a solid electrolyte. The solid electrolyte is not particularly limited as long as it can conduct lithium ions, and examples of the solid electrolyte include a solid oxide electrolyte and a solid sulfide electrolyte.

The positive electrode composite material layer may additionally contain a binder, a conductive assistant, and the like.

Examples of the method for forming the positive electrode composite material layer include, but are not particularly limited to, a method of applying a slurry containing a positive electrode active material and a solvent onto a positive electrode current collector.

Examples of the material constituting the positive electrode current collector include, but are not particularly limited to, aluminum, an aluminum alloy, stainless steel, nickel, iron, and titanium. Above all, aluminum, an aluminum alloy, and stainless steel are preferable.

Examples of the shape of the positive electrode current collector include, but are not particularly limited to, a foil shape and a plate shape.

The positive electrode composite material layer has a thickness of e.g. 0.1 μm or larger and 1000 μm or smaller.

As described above, the embodiment of the present invention has been explained. However, the present invention is not limited to the above embodiment and may be modified as appropriate within the scope of the gist of the present invention.

### EXAMPLES

Examples of the present invention will be explained below, but the present invention is not limited to these examples.

### Example 1

A solid electrolyte, a slurry, a negative electrode, and a half-cell were prepared in a glove box purged with nitrogen, as described below.

### (Preparation of Solid Electrolyte)

Li₂S, P₂S₅, LiCl, and LiBr were weighed out so as to satisfy a composition Li_{5.4}PS_{4.4}Cl_{0.8}Br_{0.8}, and then mixed using an agate mortar for 5 minutes. Subsequently, 2 g of the resulting mixture was put into a container for a planetary ball mill, to which dehydrated heptane and ZrO₂ balls were added, and the container was completely sealed. The container was attached to the planetary ball mill, and the mixture was mechanically milled at a base table rotation speed of 500 rpm for 20 hours. Subsequently, the mixture was dried at 110° C. for 1 hour to remove heptane, thereby obtaining a coarse-grained material.

The coarse-grained material was finely ground. Specifically, dehydrated heptane and dibutyl ether were mixed into the coarse-grained material, and the mixture was adjusted so that the total amount was 10 g and the solid content was 10 mass %. The resulting mixture was put into a container for a planetary ball mill, to which ZrO₂ balls were added, and the container was completely sealed. The container was attached to the planetary ball mill, and the mixture was mechanically milled at a base plate rotation speed of 150 rpm. Subsequently, the mixture was dried to obtain an argyrodite type solid sulfide electrolyte (Li_{5.4}PS_{4.4}Cl_{0.8}B_{0.8}) having a median diameter (D₅₀) of 700 nm.

### (Preparation of Slurry)

Using a rotation-revolution type mixer, 70 parts by mass of silicon-carbon composite material and 28 parts by mass of argyrodite type solid sulfide electrolyte (Li_{5.4}PS_{4.4}Cl_{0.8}Br_{0.8}) having a median diameter (D₅₀) of 700 nm were mixed. Subsequently, 2 parts by mass of polyvinylidene fluoride (PVDF) and butyl butyrate were added to the mixture, which was then mixed using a rotation-revolution type mixer and then dispersed using an ultrasonic homogenizer to obtain a slurry. Herein, butyl butyrate had a boiling point of 166° C.

### (Preparation of Negative Electrode)

The slurry was applied onto a copper foil as the negative electrode current collector, then dried, and press-formed at 980 MPa to form a negative electrode composite material layer having a thickness of 33.3 μm, thereby obtaining a negative electrode. In this process, the negative electrode was dried under normal pressure at 40° C. for 20 minutes, then dried under normal pressure at 80° C. for 20 minutes, and further dried under reduced pressure at 110° C. for 2 hours.

### Example 2

Using a rotation-revolution type mixer, 3 parts by mass of acetylene black having a median diameter (D₅₀) of 35 nm and butyl butyrate were mixed to obtain a first mixture. Subsequently, the first mixture, 35 parts by mass of argyrodite type solid sulfide electrolyte (Li_{5.4}PS_{4.4}Cl_{0.8}Br_{0.8}), 2 parts by mass of polyvinylidene fluoride (PVDF), and butyl butyrate were mixed using a rotation-revolution type mixer, and then dispersed using an ultrasonic homogenizer to obtain a second mixture. Subsequently, the second mixture, 60 parts by mass of silicon-carbon composite material, and butyl butyrate were mixed, and then dispersed using an ultrasonic homogenizer to obtain a slurry.

### (Preparation of Negative Electrode)

A negative electrode was obtained in the same manner as in Example 1 except that the obtained slurry was used. In this process, the negative electrode composite material layer had a thickness of 22.8 μm.

### Example 3

A negative electrode was obtained in the same manner as in Example 2 except that the amounts of the silicon-carbon composite material, the argyrodite type solid sulfide electrolyte (Li_{5.4}PS_{4.4}Cl_{0.8}Br_{0.8}), and acetylene black having the median diameter (D₅₀) of 35 nm were changed to 52 parts by mass, 45 parts by mass, and 1 part by mass, respectively. In this process, the negative electrode composite material layer had a thickness of 25.7 μm.

### Example 4

A negative electrode was obtained in the same manner as in Example 3 except that the amounts of the argyrodite type solid sulfide electrolyte (Li_{5.4}PS_{4.4}Cl_{0.8}Br_{0.8}) and acetylene black having the median diameter (D₅₀) of 35 nm were changed to 45.7 In this parts by mass and 0.3 part by mass, respectively. In this process, the negative electrode composite material layer had a thickness of 25.7 μm.

### Example 5

A negative electrode was obtained in the same manner as in Example 2 except that 0.3 part by mass of single-walled carbon nanotube having a diameter of 1.6 nm was used instead of 3 parts by mass of acetylene black having the median diameter (D₅₀) of 35 nm, and the amounts of the silicon-carbon composite material and the argyrodite type solid sulfide electrolyte (Li_{5.4}PS_{4.4}Cl0.8Br_{0.8}) were changed to 65 parts by mass and 32.7 parts by mass, respectively. In this process, the negative electrode composite material layer had a thickness of 20.7 μm.

### Example 6

A negative electrode was obtained in the same manner as in Example 5 except that the amounts of the silicon-carbon composite material and the argyrodite type solid sulfide electrolyte (Li_{5.4}PS_{4.4}Cl_{0.8}Br_{0.8}) were changed to 60 parts by mass and 37.7 parts by mass, respectively. In this process, the negative electrode composite material layer had a thickness of 22.0 μm.

### Example 7

A negative electrode was obtained in the same manner as in Example 5 except that the amounts of the silicon-carbon composite material, the argyrodite type solid sulfide electrolyte (Li_{5.4}PS_{4.4}Cl_{0.8}Br_{0.8}), and the single-walled carbon nanotube were changed to 52 parts by mass, 45.9 parts by mass, and 0.1 part by mass, respectively. In this process, the negative electrode composite material layer had a thickness of 24.1 μm.

### Comparative Example 1

A negative electrode was obtained in the same manner as in Example 1 except that argyrodite type solid sulfide electrolyte (Li_{5.4}PS_{4.4}Cl_{0.8}Br_{0.8}) having a median diameter (D₅₀) of 3000 nm was used instead of the argyrodite type solid sulfide electrolyte (Li_{5.4}PS_{4.4}Cl_{0.8}Br_{0.8}) having a median diameter (D₅₀) of 200 nm. In this process, the negative electrode composite material layer had a thickness of 30.8 μm.

### [Average Value S of Area Proportion Occupied by Region Attributed to Active Material, and Average Value S′ of Area Proportion Occupied by Region Attributed to Solid Electrolyte]

Using a scanning electron microscope (SEM), a 5000× first backscattered electron image of a section of the negative electrode composite material layer was acquired under a condition of an acceleration voltage of 5 kV and a probe current of 1 nA. Subsequently, a 25 μm-square region A was arbitrarily selected, and then the region A was divided into n segments (n=4, 9, 16, 25) such that the segments had uniform areas. The segments were designated as regions A1, A2, . . . , An. Then, contrast value ranges of regions A1, A2, . . . , An (region A) were trisected, i.e., the regions A1, A2, . . . , An (region A) were ternarized. In this process, based on the analysis results from an energy dispersive X-ray fluorescence spectroscopic analyzer (EDX) attached to the SEM, the ternarized regions were assigned to gaps lacking of the active material or solid electrolyte, regions attributed to the active material, and regions attributed to the solid electrolyte in an order descending from the highest contrast value range.

For each of the regions (A1, A2, . . . , An), area proportions (S1, S2, . . . , Sn) occupied by the regions attributed to the active material were calculated, and then average values Snₐᵥₑ (n=4, 9, 16, 25) of S1, S2, . . . , Sₙ were calculated. Subsequently, for S4ₐᵥₑ, S9ₐᵥₑ, S16^{ave}, and S25ₐᵥₑ, average values S were calculated.

For each of the regions (A1, A2, . . . , An), area proportions (S1′, S2′, . . . , Sn′) occupied by the regions attributed to the solid electrolyte were calculated, and then average values Snₐᵥₑ′ (n=4, 9, 16, 25) of S1′, S2′, . . . , Sn′ were calculated. Subsequently, for S4ₐᵥₑ′, S9ₐᵥₑ′, S16ₐᵥₑ′, and S25ₐᵥₑ′, average values S′ were calculated.

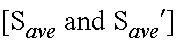

Also, for the second and third backscattered electron images, after performing the above operations, the average value Sₐᵥₑ of the average values S, the average value Sₐᵥₑ′ of the average values S′, the maximum value (S+S′)ₘₐₓ of (S+S′), and the minimum value (S+S′)ₘᵢₙ of (S+S′) were calculated.

### [Preparation of Half-Cell]

A solid sulfide electrolyte Li_{5.4}PS_{4.4}Cl_{0.8}Br_{0.8} was introduced into a cylindrical ZrO₂ tube, which was then clamped by a Steel Use Stainless (SUS) jig and pressed to obtain a solid electrolyte pellet. Subsequently, the solid electrolyte pellet and the negative electrode were stacked, and then loaded with a forming pressure to form a solid electrolyte layer. Subsequently, a lithium foil was laminated on the solid electrolyte layer on the side opposed to the negative electrode, which was then constrained at 3 MPa to obtain a half-cell. For each example, 3 half-cells were prepared.

### [Initial Discharge Capacity]

The half-cell was constrained at 0.5 to 2 MPa and then subjected to an initial charging/discharging at a ⅓ C rate, and an initial discharge capacity was measured. In this process, 3 half-cells were used, and their average value of the initial discharge capacity was calculated.

### [Unevenness in Initial Discharge Capacity]

The maximum, minimum, and average values of the initial discharge capacity for the 3 half-cells were calculated, and an unevenness in the initial discharge capacity of the half-cells was calculated according to the following equation:

$$[ ( Maximum initial discharge capacity ) - ( Minimum initial discharge capacity ) ] / ( Average initial discharge capacity ) .$$

Table 1 presents the evaluation results for the initial discharge capacities and the unevenness in the initial discharge capacities of the half-cells.

TABLE 1

| | | | | | | Initial | Unevenness |
|---|---|---|---|---|---|---|---|
| | | [(S + S′)ₘₐₓ | | | | discharge | in initial |
| | S + S′ | (S + S′)ₘᵢₙ] / | Sₐᵥₑ | Sₐᵥₑ′ | D50 of solid | capacity | discharge |
| | [%] | (Sₐᵥₑ + Sₐᵥₑ′) [—] | [%] | [%] | electrolyte [nm] | [mAh/g] | capacity [—] |
| Example1 | 93.07 | 0.035 | 73.75 | 19.31 | 700 | 890 | 0.377 |
| Example2 | 94.07 | 0.073 | 73.02 | 21.05 | 700 | 1257 | 0.095 |
| Example3 | 95.34 | 0.078 | 62.45 | 32.89 | 700 | 1354 | 0.016 |
| Example4 | 95.84 | 0.014 | 62.50 | 33.34 | 700 | 1379 | 0.012 |
| Example5 | 95.12 | 0.108 | 75.25 | 19.87 | 700 | 1331 | 0.009 |
| Example6 | 96.95 | 0.207 | 72.80 | 24.15 | 700 | 1347 | 0.002 |
| Example7 | 96.00 | 0.110 | 64.07 | 31.93 | 700 | 1404 | 0.002 |
| Comparative | 89.30 | 0.257 | 73.35 | 15.95 | 3000 | 487 | 1.380 |
| Example1 | | | | | | | |

Table 1 indicates that, when using the negative electrodes of Examples 1 to 7, the half-cell has a high initial discharge capacity and a small unevenness in the initial discharge capacity. In contrast, in the negative electrode of Comparative Example 1, the solution of equation S+S′ is 89.30%, and the solution of equation [(S+S′)ₘₐₓ−(S+S′)ₘᵢₙ]/(Sₐᵥₑ+Sₐᵥₑ′) is 0.257, and therefore the half-cell has a low initial discharge capacity and a large unevenness in the initial discharge capacity.

What is claimed is:

1. A negative electrode comprising a negative electrode composite material layer containing a silicon-based active material and a solid electrolyte, wherein the following equation is satisfied:
$$90 \leq S + {S}^{′} ,$$
the average values S and the average values S′ are determined through a process that a 25 μm-square region in a 5000× backscattered electron image of a section of the negative electrode composite material layer is divided into X₁ segments, into X₂ segments, . . . into Xₙ₋₁ segments, and into Xₙ segments (X₁, X₂, . . . , Xₙ₋₁, and Xₙ are each different integers of 2 or larger) such that the segments have uniform areas, then average values SX_{1,ave} [%], SX_{2,ave} [%], . . . , SX_{n-1,ave} [%], and SX_{n,ave} [%] of area proportions [%] occupied by regions attributed to the silicon-based active material as well as average values SX_{1,ave}′ [%], SX_{2,ave}′ [%], . . . , SX_{n-1,ave}′ [%], and SX_{n,ave}′ [%] of area proportions [%] occupied by regions attributed to the solid electrolyte in ternarized regions are determined, and then average values S [%] of SX_{1,ave}, SX_{2,ave}, . . . , SX_{n-1,ave}, and SX_{n,ave}, as well as average values S′ [%] of SX_{1,ave}′, SX_{2,ave}′, . . . , SX_{n-1,ave}′ [%], and SX_{n,ave}′ [%] are determined.

2. The negative electrode according to claim 1, wherein an average value Sₐᵥₑ′ [8] of the average values S′ satisfies the following equation:
$$10 \leq {S}_{ave}^{′} \leq 50.$$

3. The negative electrode according to claim 1, wherein an average value Sₐᵥₑ [%] of the average values S satisfies the following equation:
$$50 \leq {S}_{a v e} \leq 80 .$$

4. The negative electrode according to claim 1, wherein the solid electrolyte has a median diameter of 100 nm or larger and 1000 nm or smaller.

5. The negative electrode according to claim 1, wherein the negative electrode composite material layer has a solid electrolyte content of 10 mass % or more and 50 mass % or less.

6. The negative electrode according to claim 1, wherein the negative electrode composite material layer has a silicon-based active material content of 50 mass % or more and 80 mass or less.

7. The negative electrode according to claim 1, wherein the negative electrode composite material layer additionally contains a conductive assistant.

8. The negative electrode according to claim 7, wherein the negative electrode composite material layer has a conductive assistant content of 0.1 mass % or more and 5 mass % or less.

9. The negative electrode according to claim 7, wherein the conductive assistant is carbon.

10. The negative electrode according to claim 7, wherein the conductive assistant is a particle having a median diameter of 10 nm or larger and 100 nm or smaller, or a fiber having a diameter of 1 nm or larger and 10 nm or smaller.

11. The negative electrode according to claim 1, wherein the solid electrolyte is a solid sulfide electrolyte.

12. The negative electrode according to claim 11, wherein the solid sulfide electrolyte is an argyrodite type solid sulfide electrolyte.

13. A negative electrode comprising a negative electrode composite material layer containing a silicon-based active material and a solid electrolyte, wherein an average value Sₐᵥₑ [%] of average values S, an average value Sₐᵥₑ′ [%] of average values S′, the maximum value (S+S′)ₘₐₓ of (S+S′), and the minimum value (S+S′)ₘᵢₙ of (S+S′) satisfy the following equation:
$$[ {( S + {S}^{′} )}_{max} - {( S + {S}^{′} )}_{min} ] / ( {S}_{ave} + {S}_{ave}^{′} ) \leq 0.1 ,$$
the average value Sₐᵥₑ of the average values S and the average value Sₐᵥₑ′ of the average values S′ are determined through a process that a 25 μm-square region in a 5000× backscattered electron image of a section of the negative electrode composite material layer is divided into X₁ segments, into X₂ segments, . . . into Xₙ₋₁ segments, and into Xₙ segments (X₁, X₂, . . . , Xₙ₋₁, and Xₙ are each different integers of 2 or larger) such that the segments have uniform areas, then average values SX_{1,ave} [%], SX_{2,ave} [%], . . . , SX_{n-1,ave} [%], and SX_{n,ave} [%] of area proportions [%] occupied by regions attributed to the silicon-based active material as well as average values SX_{1,ave}′ [%], SX_{2,ave}′ [%], . . . , SX_{n-1,ave}′ [%], and SX_{n,ave}′ [%] of area proportions [%] occupied by regions attributed to the solid electrolyte in ternarized regions are determined, and then average values S [%] of SX_{1,ave}, SX_{2,ave}, . . . , SX_{n-1,ave}, and SX_{n,ave}, as well as average values S′ [%] of SX_{1,ave}′, SX_{2,ave}′, . . . , SX_{n-1,ave}′, and SX_{n,ave}′ are determined.

14. A solid lithium ion battery comprising the negative electrode according to claim 1.

15. A negative electrode manufacturing method according to claim 1, comprising:
applying a slurry containing the silicon-based active material, the solid electrolyte, and a solvent onto a negative electrode current collector to form the negative electrode composite material layer, wherein the solvent has a boiling point of 120° C. or higher.

16. The negative electrode manufacturing method according to claim 15, wherein the applied slurry is heat-dried under normal pressure, then heat-dried under reduced pressure to form the negative electrode composite material layer.

17. The negative electrode manufacturing method according to claim 15, additionally comprising:
mixing a conductive assistant and the solvent to obtain a first mixture;
mixing the first mixture, the solid electrolyte, and the solvent to obtain a second mixture; and
mixing the second mixture, the silicon-based active material, and the solvent to obtain the slurry.
